(19) United States
(12) Patent Application Publication
(10) Pub. No.: US 2024/0261910 A1
(43) Pub. Date: Aug. 8, 2024

(54) METHOD AND DEVICE FOR WELDING BLADES

(71) Applicant: PIA AUTOMATION HOLDING GMBH, Bad Neustadt a.d. Saale (DE)

(72) Inventors: Hubert SCHOENER, Wernberg-Koeblitz (DE); Christoph HELMS, Amberg (DE); Michael BAUER, Sulzbach-Rosenberg (DE)

(21) Appl. No.: 18/568,804

(22) PCT Filed: May 31, 2022
(86) PCT No.: PCT/EP2022/064763

§ 371 Date: Jan. 8, 2024

(30) Foreign Application Priority Data
Jun. 9, 2021 (DE) 10 2021 114 813.8

(51) Int. Cl. B23K 37/047; B23K 37/04

(52) U.S. Cl. CPC B23K 37/047; B23K 37/0452

(57) ABSTRACT

The invention relates to a device and a method for welding blades, in particular in order to produce a cutting unit for a wet razor. According to the invention, a rotary indexing table is used so that an adaptable and easily scalable device or an adaptable and easily scalable method for welding blades is provided for this purpose.

### CROSS REFERENCE TO RELATED APPLICATION

This application is a national stage for International Application PCT/EP2022/064763, filed on May 31, 2022, which claims the priority benefit of German Patent Application No. 102021114813.8, filed on Jun. 9, 2021. The contents of the above identified applications are hereby incorporated herein in their entireties by reference.

### TECHNICAL FIELD

The application relates to an apparatus for welding blades, in particular for wet-shave razors.

The application also relates to a method for welding such blades.

### BACKGROUND

For some time now, commercially available wet-shave razors have had a shaving head which is fixed to a handle or is exchangeable, the shaving head including a cutting unit. In models of wet-shave razors or shaving heads which are particularly designed for a close shave which is kind to the skin, the shaving heads have a plurality of parallel blades arranged in a cutting unit.

As far as corresponding shaving heads and cutting units of this type are concerned, various designs and production methods including for example the arrangement of blades in receiving slits in the shaving head, or the welding of blades on a carrier frame, are already known.

Embodiments in which a respective blade is welded on an individual carrier and embodiments in which a plurality of blades are welded on a common carrier frame are known.

### SUMMARY

The present application is concerned with the production of cutting units in which a plurality of blades are welded on a common carrier frame.

Known apparatuses and methods for welding blades often provide merely restricted scalability in terms of the number of cutting units produced in a specific period of time. Furthermore, work carried out on known production installations, for example during maintenance or servicing, often requires the entire installation to be brought to a standstill, and therefore production is completely shut down during this period of time.

It is therefore an object of the application to specify an apparatus for welding blades which provides both improved scalability in terms of the number of cutting units produced in a specific period of time and good availability of the installation as a whole.

It is a further object of the application to specify a method for welding blades which provides both improved scalability in terms of the number of cutting units produced in a specific period of time and good availability of the installation as a whole.

In an apparatus for welding blades and having a blade-supply device for supplying blades, having a welding apparatus for the welding of one or more blades to a carrier frame to form a cutting unit, and having at least one holder device for holding at least one carrier frame, the application makes provision for it to include a rotary indexing table with a plurality of processing stations around a turntable, wherein the blade-supply device is a constituent part of a blade-feeding station, and the welding apparatus is a constituent part of a welding station, of the rotary indexing table and wherein the apparatus has suitable means for feeding a carrier frame into the operating region of the welding station, for orienting the carrier frame in the welding station and for removing a cutting unit produced from the carrier frame and one or more blades.

The application therefore relates, in particular, to the process of feeding and welding blades in the overall process of producing a shaving unit. This interim process is used in the production of cutting units for wet-shave razors in which one or more blades are welded on a carrier frame to form a cutting unit. Depending on the design of the cutting unit, it is correspondingly possible for preceding and/or following mounting steps to be necessary in order to complete the cutting unit.

It is often the case that such cutting units include a plurality of blades for normal shaving and an additional trimmer blade. Depending on the design of the cutting unit, the trimmer blade—if the cutting unit to be produced is to have one such—either is incorporated in the apparatus for welding blades, which will be described herein below, or is mounted separately in a preceding or following mounting step. The cutting unit is then usually a subassembly of the shaving unit as a whole.

An apparatus for welding blades according to the application has at least one rotary indexing table. Such a rotary indexing table has a number of processing stations, which are positioned around a turntable of the rotary indexing table and are designed for interacting with tools arranged on the rotary indexing table and/or with a workpiece positioned on the rotary indexing table.

For example, such a rotary indexing table has six or eight processing stations. The processing stations are usually spaced apart at regular intervals in the circumferential direction, i.e. in angular positions which differ by 60° in the case of six processing stations and in angular positions which differ by 45° in the case of eight processing stations.

The turntable of the rotary indexing table is rotatable about a usually vertical or horizontal axis of rotation, so that a workpiece arranged in a mount on the turntable of the rotary indexing table, depending on the respective angular position of the respective mount on the rotary indexing table, can be moved or shifted successively into the operating region of the processing stations.

The number and arrangement of the mounts on the rotary indexing table usually correspond to the processing stations. However, it is possible for one or more processing stations to remain empty, i.e. for the rotary indexing table to have for example in each case six mounts on the turntable and six processing stations, even though fewer than six, for example only three, processing stations are set up in functional terms.

In preferred embodiments of the application, use is made of a rotary indexing table designed in the form of a torque rotary table. Torque rotary tables have the advantage over mechanical rotary indexing tables that the indexing-angle-pitch error is usually significantly smaller. The control of a torque rotary table means that the angular positions of the individual processing stations, in addition, are controllable with a higher level of accuracy.

In preferred embodiments of the application, the mounts on the rotary indexing table are designed in the form of positioning wings, which are intended for receiving, for transporting and for positioning the blades on the rotary indexing table.

The positioning wings are configured to be preferably spring-mounted and movable in each case perpendicularly in relation to the surface of the rotary indexing table.

The movement of the positioning wings is achieved by way of a respective lifting unit which, in the case of the surface of the rotary indexing table being oriented horizontally, is designed in the form of a vertical lifting unit. The positioning wings, in this case, are movable perpendicularly in relation to the surface of the turntable with the aid of a lifting unit.

In particularly advantageous embodiments of the application, the lifting unit is synchronized with the rotary movement of the rotary indexing table. This allows a distance of the receiving device of the positioning wing for a blade from the turntable to be adapted to the requirements of the respective processing station. This can be done for example either mechanically, for example by way of a cam mechanism, or electronically, for example by way of a servo drive.

In a preferred embodiment of the application, the positioning wings are arranged on the rotary indexing table such that the cutting edge of a blade held in the receiving device of a positioning wing is arranged tangentially in relation to the turntable of the rotary indexing table. This minimizes the influence of an indexing-angle-pitch error and/or position error of the rotary indexing table on the position of the cutting edge of the blade.

The first processing station of the rotary indexing table that is essential to the application is, in particular, the blade-feeding station. The blade-feeding station has a blade-supply device for supplying blades.

In an embodiment of the application, the blade-supply device is designed in the form of a blade-storage device for storing blades. For example, such a blade-storage device is designed in the form of a blade magazine in which the individual blades are supplied one above the other in the form of a stack.

In some embodiments of the application, the blade-storage device has a divider slide, by means of which a respective individual blade can be conveyed out of the blade magazine and supplied for further processing. In preferred embodiments of the application, such a divider blade has its movement synchronized with the rotary indexing table, so that a blade is supplied for example in each process interval. The synchronization here can be done for example mechanically, for example with the aid of a cam mechanism, or electronically, for example with the aid of a servo drive.

A respective individual blade can be received by the blade-supply device with the aid of the positioning wing on the turntable that is located in the position of the blade-feeding station.

The second processing station of the rotary indexing table that is essential to the application is the welding station. The welding station has a welding apparatus, by means of which the blades can be welded to the carrier frame. In an embodiment of the application, the welding apparatus is designed for the laser welding of the blades.

It is also advantageous if the apparatus for welding blades has suitable means for feeding an empty carrier frame into the operating region of the welding station, for orienting the carrier frame in the welding station and for removing from the operating region of the welding station a finish-welded cutting unit produced from the carrier frame and at least one blade.

For the purpose of feeding an empty carrier frame into the operating region of the welding station, the apparatus for welding blades has a suitable handling device, for example a pick & place handling unit, by means of which a carrier frame can be received from a supply position by an interface apparatus and can be placed in a holder device located in a transfer region.

In some embodiments of the application, this holder device is designed in the form of a processing cavity which is not movable in circulation with the turntable of the rotary indexing table, or is movable in circulation therewith only over a limited angular range; in the first-mentioned case, the processing cavity remains in the operating region of the first processing station.

The supply position of the carrier frame can be realized, for example, by an interface apparatus designed in the form of a storage magazine for carrier frames, a parts-logistics unit or a shuttle system.

In preferred embodiments of the application, the holder device has in each case at least one axial handling unit, by means of which the carrier frame can be positioned in the holder device, and/or together with the holder device, for processing purposes and/or for being equipped with blades.

Preferably, a three-way axial handling unit having two linear axes, which are perpendicular in relation to one another and are oriented parallel to the surface of the turntable of the rotary indexing table, and an axis of rotation, which is perpendicular in relation to the linear axes, is used for this purpose.

The linear axes allow positioning of the carrier frame in the processing station, for example in the welding station during the welding operation and for transfer purposes following the welding operation. With the aid of the axis of rotation, it is possible to correct the angular position between blades and carrier frames and it is possible to mount blades with different orientations, for example a trimmer blade rotated through 180°.

In some embodiments of the application, with the aid of the movement along the linear axes, the holder device is displaceable from the transfer region of the handling device into the operating region of the welding station of the rotary indexing table.

According to the application, it is also possible to provide embodiments having two axial handling units for each holder device, these ensuring a continuous process for the placement and welding of the blades.

While it is the case in such an embodiment of the application that a first axial handling unit, in cooperation with the rotary indexing table, is assigned to repositioning the carrier frame when the blades are being welded, the second axial handling unit, in cooperation with the handling device for the carrier frames, is assigned to transferring the finish-welded cutting units to the parts-logistics unit and equipping the holder device with a new carrier frame, wherein the holder device or the processing cavity can remain rigidly positioned.

In another embodiment, the apparatus for welding blades has at least one double holder device for receiving two carrier frames one beside the other, wherein the double holder device is assigned a single axial handling unit common to the two carrier frames. The individual carrier frames here can be positioned at the processing station one after the other, with the aid of the axial handling unit, in order for the respective process step to be carried out.

The at least one axial handling unit assigned to the holder device is also designed so that the welded cutting device produced from the carrier frame and one or more blades is thereby transported out of the welding station into the transfer region of a handling apparatus.

In preferred embodiments of the application, the same handling device is designed both for equipping the holder devices with empty carrier frames and for transferring the cutting units out of the holder devices onto an interface apparatus.

In addition to the essential processing stations on the rotary indexing table, an advantageous apparatus for welding blades can have one or more of the following processing stations on the rotary indexing table itself or in the immediate vicinity thereof.

An optional blade-cutting station on the rotary indexing table serves for cutting the blades to the required width and is necessary only when the blades supplied and transferred at the bladefeeding station do not have the width required for the cutting unit to be produced.

In some embodiments of the application, a blade-cutting station has a blade-cutting unit and a clamping unit. With the aid of the clamping unit, the positioning wing of the respective mount of the rotary indexing table can be clamped with the blade and, with the aid of the cutting unit, the blade can be cut to the necessary width.

The cutting unit can be designed, for example, for cutting the blades by a driven cutting knife or by laser cutting.

In preferred embodiments, the movement of the clamping unit and possibly of the cutting blade of the cutting unit is synchronized with the rotary indexing table. The synchronization here can be done for example mechanically, for example with the aid of a cam mechanism, or electronically, for example with the aid of a servo drive.

An optional checking station on the rotary indexing table can be designed, for example, for checking the blades before and/or after the blades are cut to size or positioned on the carrier frame.

An optional checking station in the immediate vicinity of the rotary indexing table, i.e. not one of the processing station assigned to the rotary indexing table in the various angular positions, can be designed, for example, for the quality control of the finish-welded cutting units.

A checking station can have, for example, at least one optoelectronic sensor, for example a camera, a magneto-optical sensor or X-ray equipment.

A further optional processing station is constituted by a cleaning station, which is designed for example for cleaning a finish-welded cutting unit or individual blades and/or carrier frames.

Another optional processing station is constituted by a lettering station, at which individual blades or carrier frames or the cutting unit can be provided with lettering or writing by suitable means.

However, other processing stations which have not been mentioned here are also possible.

A method for welding blades according to the application includes at least the following method steps:
a) providing a carrier frame
b) transferring the carrier frame into a holder device with the aid of a handling apparatus
c) displacing the holder device with the carrier frame into the operating region of a processing station of a rotary indexing table
d) providing a blade by a blade-supply device at a blade-feeding station of the rotary indexing table
e) receiving the blade by a positioning wing on the turntable of the rotary indexing table at the blade-feeding station
f) moving the rotary indexing table at regular intervals until the blade held in the positioning wing has reached the processing station in the operating region of which the carrier frame is held in the holder device
g) orienting the carrier frame in the holder device in relation to the blade with the aid of an axial handling unit
h) placing the blade in the envisaged position on the carrier frame with the aid of the positioning wing
i) welding the blade to the carrier frame with the aid of a welding device.

The entire sequence, or part of the sequence, of the carrier frame being supplied and placed in the holder device and of the carrier frame being moved into the operating region of a processing station of the rotary indexing table (steps a to c) and of the blade being received and of regular-interval movement as far as the processing station in the operating region of which the carrier frame is held in the processing cavity (steps d to f) can also be reversed, i.e. first of all steps d to f and then steps a to c, or these steps can proceed fully or partially in parallel.

If cutting units having a plurality of blades are to be produced, then method steps d) to i) are repeated until the cutting unit has the envisaged number of blades.

As an alternative, the operations of equipping the carrier frame and of welding can also proceed such that first of all a plurality of, or all, the envisaged blades are positioned on the carrier frame and only then are they welded thereto.

In preferred embodiments of the method according to the application, method steps g) to i) proceed in the welding station (6a) of the rotary indexing table (2).

The following optional method steps, in all feasible combinations, can be contained fully or partially in a method according to the application for welding blades:
the rotary indexing table is moved at regular intervals until the blade held in the positioning wing has reached the operating region of a blade-cutting station
the positioning wing and/or the blade are/is clamped with the aid of a clamping unit
the blade is cut to the required width
the rotary indexing table is moved at regular intervals until the blade held in the positioning wing has reached the operating region of a cleaning station
the blade is cleaned
It is possibly also the case that, in the cleaning station, the positioning wings are cleaned without a blade therein, so that contamination which occurs during the welding operation is removed again.
the rotary indexing table is moved at regular intervals until the blade held in the positioning wing has reached the operating region of a checking station
the blade is checked by appropriate checking means
the finished cutting units are checked, that is to say with the blade(s) welded to the carrier frame,
the rotary indexing table is moved at regular intervals until the blade held in the positioning wing has reached the operating region of a lettering station
the blade is provided with lettering or writing by suitable means,
the finished cutting units are provided with lettering or writing.

Of course, the aforementioned method steps can only take place following the essential method steps d) and e), in which the blade is first received in the respective positioning wing.

In some embodiments of the application, method step d) is realized as follows: A blade is supplied with the aid of a blade-storage device designed in the form of a blade magazine, in that a blade is divided off, with the aid of a divider slide, from the blade stack of the blade magazine and displaced into a transfer position, in which the blade is received by a positioning wing in accordance with method step e).

In a preferred embodiment of the method according to the application, a blade is received at the blade-feeding station with the aid of a positioning wing in one operating interval of the rotary indexing table and, in one or more regular intervals, it is moved on to a blade-cutting station, where it is cut to the necessary width, and then, in one or more regular intervals, it is moved on to a welding station, steps g) and h) being carried out in the welding station.

In an embodiment of a method for welding blades according to the application, the holder device is moved with the aid of a first axial handling unit and a second axial handling unit, wherein one of the axial handling units, in cooperation with the rotary indexing table, repositions the carrier frame when the blades are being welded and the respectively other axial handling unit, in cooperation with the handling device for the carrier frames, positions the holder device for the purposes of transferring the finish-welded cutting units to the interface apparatus and of equipping the holder device with a new carrier frame, wherein the holder device remains rigidly positioned. The first and the second axial handling units here perform the respective tasks preferably in alternating fashion.

In an embodiment of a method for welding blades according to the application, the positioning wings are moved by a respective lifting unit so that the distance of a blade held in the positioning wing, or of the receiving device of the positioning wing, from the turntable is adapted in dependence on the requirements of the respective processing station. The lifting operation here takes place preferably when the turntable is moving, so as to avoid any collisions with one of the processing stations.

In an embodiment of a method for welding blades according to the application, the movement of the lifting units and/or the procedure at at least one processing station is synchronized with the movement and/or the angular position of the turntable of the rotary indexing table.

In a preferred embodiment of a method for welding blades according to the application, at least one apparatus for welding blades according to the application is used.

The above-described functional constituent parts of the apparatus for welding blades are then used correspondingly, in feasible combinations, in embodiments of the method.

In an embodiment of the application, the method for welding blades is designed for producing cutting units for wet-shave razors, wherein not all the steps which are needed to produce the finished cutting unit necessarily have to be included.

### BRIEF DESCRIPTION OF THE DRAWINGS

Further features, details and advantages of the application can be gathered from the wording of the claims and from the following description of exemplary embodiments with reference to the drawings, in which:

FIG. 1 shows a schematic illustration of an embodiment of an apparatus for welding blades according to the application,

FIG. 2 shows a schematic illustration of an alternative embodiment of an apparatus for welding blades according to the application,

FIG. 3 shows a schematic illustration of a further alternative embodiment of an apparatus for welding blades according to the application, and

FIG. 4 shows a schematic side view of a positioning wing.

### DETAILED DESCRIPTION OF THE EMBODIMENTS

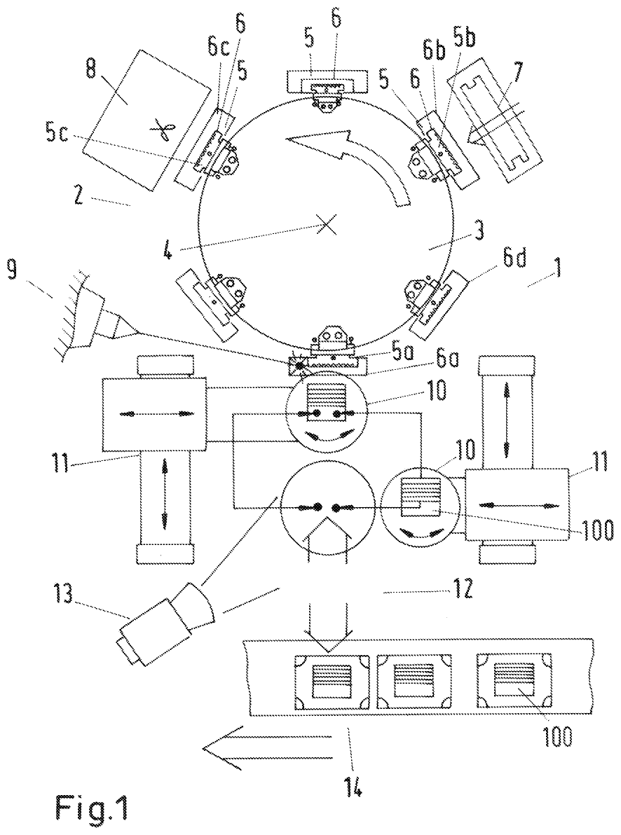

The embodiment of an apparatus for cutting blades 1 according to the application which is illustrated schematically in FIG. 1 has a rotary indexing table 2 with a turntable 3. The turntable 3 is mounted rotatably about an axis of rotation 4.

Mounts 5 designed in the form of positioning wings are arranged on the turntable 3. Corresponding to the six mounts 5 in this case, it is likewise the case that six processing stations 6 are arranged around the turntable 3.

A first processing station 6 is designed in the form of a welding station 6a. A second processing station 6 is designed in the form of a blade-feeding station 6b and has a blade-supply device 7.

A third processing station 6 is designed in the form of a blade-cutting station 6c and has a blade-cutting device 8. The other three processing stations 6 are designed in the form of empty processing stations 6d, which in the embodiment illustrated have no specific function. It is possible, in modified embodiments of the application, for further functional processing stations 6 to be provided instead of these empty processing stations 6d.

The direction of rotation of the turntable 3 is indicated by an arrow. The arrangement or sequence of the processing stations 6 has to correspond to the envisaged processing steps in the direction of rotation of the turntable 3.

The welding station 6a has a welding apparatus 9, which in the present case is designed for the laser welding of the blades and of the carrier frame 100. The carrier frame 100 can be held, in the region of the rotary indexing table 2, with the aid of a holder device 10, which is designed for example in the form of a processing cavity.

In the embodiment illustrated, each holder device 10 is designed for holding a carrier frame 100 and has a respective axial handling unit 11, by means of which the holder device 10 is movable along two linear axes parallel to the surface of the turntable 3, and an axis of rotation, for orientation in the operating region of the processing station 6.

With the aid of the axial handling unit 11, it is possible to orient the carrier frame 100 in the welding station 6d in particular also for one or more blades to be received in the carrier frame 100 in predetermined positions. The carrier frame 100 here is usually moved successively, in the radial direction of the turntable 3, into predetermined positions at the appropriate blade spacing, in order for three or four blades to be received.

Furthermore, the holder device 10 is displaceable, with the aid of the respective axial handling unit 11, into the transfer region of a handling apparatus 12. In the exemplary embodiment illustrated, the handling apparatus is designed in the form of a pick & place handling unit.

With the aid of the handling apparatus 12, a carrier frame 100 which has been equipped with blades and processed to form a cutting unit is transferable to an interface apparatus 14, in the present case designed in the form of the conveyor belt of a parts-logistics unit, which serves as the interface to possible further processing steps. In addition, the carrier frames 100 which have not been equipped with blades are transferable from the interface apparatus 14 into a holder device 10 with the aid of the same handling apparatus 12.

In the transfer region of the handling apparatus 12, the blade-containing carrier frames 100 which have been processed to form the cutting unit can be checked with the aid of a checking device 13, for example checks can be made relating to the quality of the welding locations and/or as to whether the carrier frame 100 has been correctly equipped.

A method for welding blades according to the application using the embodiment of an apparatus for welding blades 1 according to the application from FIG. 1 proceeds as follows.

First of all, a carrier frame 100 is transferred from the interface apparatus 14 into a holder device 10 with the aid of the handling apparatus 12. The carrier frame 100 held in the holder device 10, with the aid of the axial handling unit 11 assigned to the holder device 10, is transported into the operating region of the welding station 6a and oriented in order to receive a first blade from the positioning wing 5 which has been moved at regular intervals into the corresponding processing station 6.

The blade held in the positioning wing 5 was previously equipped with a blade, over a number of operating cycles of the rotary indexing table 2, in the first instance in the blade-feeding station 6b. The blade was then cut to the necessary width in the blade-cutting station 6c and the positioning wing 5 holding the blade was then moved on into the operating region of the welding station 6a.

The blade positioned in the carrier frame 100 is subsequently welded on the carrier frame 100 with the aid of the welding apparatus 9. The carrier frame 100 is then displaced, with the aid of the axial handling unit 11, into the position for receiving a further blade—which was received by a positioning wing 5, and processed, as described above—until the carrier frame 100 has been fully equipped and processed to form the desired cutting unit.

The cutting unit is then displaced, with the aid of the axial handling unit 11, out of the operating region of the processing station 6 of the rotary indexing table 3 into the transfer region of the handling device 12 and is transferred, with the aid of the handling unit 12, to the interface apparatus 14.

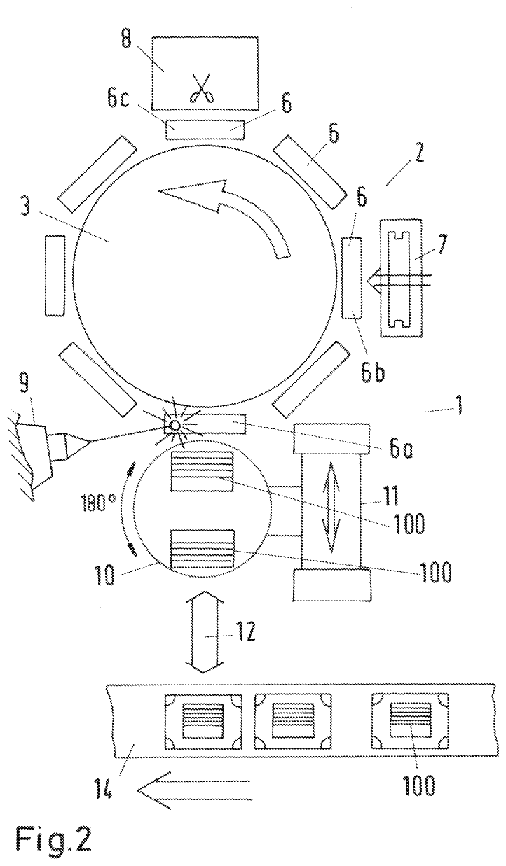

That embodiment of an apparatus for welding blades 1 which is illustrated schematically in FIG. 2 differs from FIG. 1 in the first instance by way of the number of processing stations 6, the rotary indexing table 2 here having eight processing stations 6. Correspondingly, eight positioning wings 5 (not illustrated) are arranged on the turntable 3. For reasons of clarity, the positioning wings are not illustrated, but they are provided in a manner analogous to the embodiment according to FIG. 1.

In addition, the variant of FIG. 2 also differs from FIG. 1 in that it has a holder device 10 which is designed in the form of a double holder device and is intended for holding two carrier frames 100 beside one another, a single axial handling unit 11 being provided here.

Although this embodiment does allow for a more straightforward and cost-effective design, it nevertheless has to be accepted that there will be stoppage times while the blades are being welded, during transfer of the cutting units and of the carrier frames 100 by the handling apparatus 12.

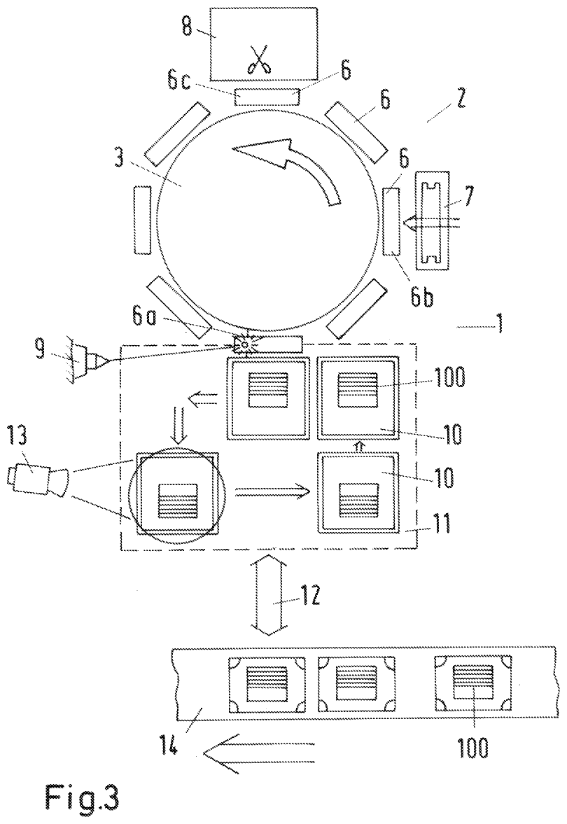

The further embodiment of an apparatus according to the application for welding blades 1 which is illustrated in FIG. 3 has a further modification in the region of the holder device 10 and of the axial handling unit 11. For reasons of clarity, the positioning wings are not illustrated, but they are provided in a manner analogous to the embodiment according to FIG. 1.

This particular embodiment realizes a shuttle system in which a plurality of holder devices 10 are movable, with the aid of at least one axial handling unit 11, along two linear axes in a single plane, so that these holder devices are movable between the transfer position of the handling device 12 and the operating region of the welding station 6a on the rotary indexing table 2.

In all the embodiments according to the application, it is possible for the carrier frames 100 held in the holder device 10 or for the cutting units to be subjected to additional processing steps.

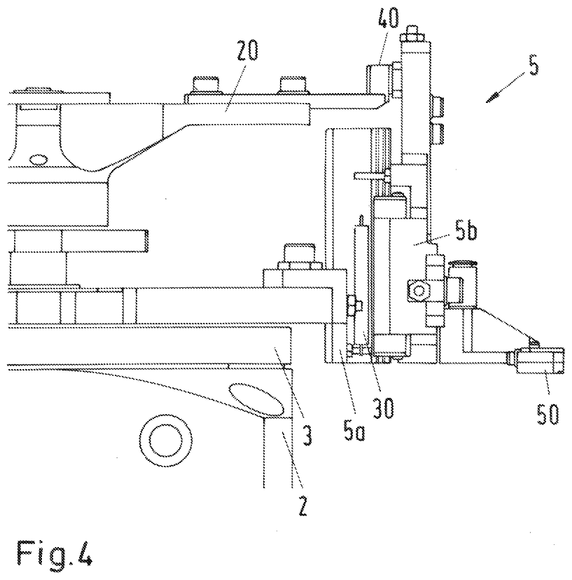

FIG. 4 shows a schematic side view of a mount 5, which is designed in the form of a positioning wing and serves for receiving, for transporting and for positioning the blades on the rotary indexing table. The positioning wing 5 is made up of an inner positioning-wing part 5a and an outer positioning-wing part 5b. The outer positioning-wing part 5b is movable in relation to the inner positioning-wing part 5a, by means of a lifting unit 20, in a direction perpendicular to the surface of the rotary indexing table 2 and/or of the turntable 3. The inner positioning-wing part 5a here is screwed to the turntable 3, and is therefore fastened immovably in relation to the same.

The outer positioning-wing part 5b is pulled vertically downward, with the aid of a spring element 30 designed in the form of a tension spring, in the direction of the turntable 3 and/or of the inner positioning-wing part 5a. Arranged at an upper end of the outer positioning-wing part 5b is a carry-along roller 40, which rests on the lifting unit 20. During a lifting movement of the lifting unit 20, the outer positioning-wing part 5b is therefore carried along upward, counter to the force of the spring element 30, by the turntable 3. A blade 40 fastened at a lower end of the outer positioning-wing part, in this case by means of a vacuum, is likewise lifted in the process. As an alternative, it would also be possible to use other ways of fixing the blade in place, for example adhesion, mechanical gripping and the like.

The application is not restricted to one of the embodiments described above, but can be modified in various ways. It is therefore possible, for example, to vary the number of processing stations and/or of positioning wings or mounts.

All of the features and advantages which can be gathered from the claims, the description and the drawing, including structural details, spatial arrangements and method steps, may be essential to the application both individually and in a wide variety of different combinations.

1. An apparatus for welding blades comprising:
a blade-supply device for supplying blades;
a welding apparatus for welding one or more blades to a carrier frame to form a cutting unit; and
at least one holder device (10) for holding at least one carrier frame,
the apparatus further comprises a rotary indexing table with a plurality of processing stations around a turntable,
wherein the blade-supply device is a constituent part of a blade-feeding station, and the welding apparatus is a constituent part of a welding station of the rotary indexing table and wherein the apparatus has suitable means for feeding a carrier frame into the operating region of the welding station, for orienting the carrier frame in the welding station and for removing a cutting unit produced from the carrier frame and one or more blades.

2. The apparatus of claim 1, wherein the rotary indexing table is designed in the form of a torque rotary table.

3. The apparatus of claim 1, wherein the turntable is configured with mounts designed in the form of positioning wings, wherein the positioning wings are arranged on the turntable such that the cutting edge of a blade held in a positioning wing is oriented tangentially in relation to the turntable.

4. The apparatus of claim 3, wherein the positioning wings are movable perpendicularly in relation to the surface of the turntable with the aid of a lifting unit.

5. The apparatus of claim 4, wherein the movement of the positioning wings is synchronized with the rotary movement of the turntable with the aid of the lifting unit.

6. The apparatus of claim 1, further comprising at least one holder device for holding a carrier frame, wherein the holder device is assigned at least one axial handling unit for moving and orienting the holder device.

7. The apparatus of claim 6, wherein a respective holder device is assigned two axial handling units.

8. The apparatus of claim 6, wherein the holder device is designed in the form of a double holder device for simultaneously receiving two carrier frames one beside the other, wherein the double holder device is assigned a single axial handling unit.

9. The apparatus of claim 1, further comprising a shuttle system for feeding carrier frames into the operating region of the welding station and for removing the cutting units from the operating region of the welding station.

10. A method for welding blades, comprising following method steps:
a) providing a carrier frame;
b) transferring the carrier frame into a holder device with the aid of a handling apparatus;
c) displacing the holder device with the carrier frame into the operating region of a processing station of a rotary indexing table;
d) providing a blade by a blade-supply device at a blade-feeding station of the rotary indexing table;
e) receiving the blade by a positioning wing on the turntable of the rotary indexing table at the blade-feeding station;
f) moving the rotary indexing table at regular intervals until the blade held in the positioning wing has reached the processing station in the operating region of which the carrier frame is held in the holder device;
g) orienting the carrier frame in the holder device in relation to the blade with the aid of an axial handling unit;
h) placing the blade in the envisaged position on the carrier frame with the aid of the positioning wing; and
i) welding the blade to the carrier frame with the aid of a welding device.

11. The method of claim 10, wherein steps d) to i) are re-peated until such time as the cutting unit has an envisaged number of blades.

12. The method of claim 10, wherein the holder device is moved with the aid of a first axial handling unit and a second axial handling unit, wherein the first axial handling unit, in cooperation with the rotary indexing table, repositions the carrier frame when the blades are being welded and the second axial handling unit, in cooperation with the handling device for the carrier frames, positions the holder device for the purposes of transferring the finish-welded cutting units to the interface apparatus and of equipping the holder device with a new carrier frame, wherein the holder device remains rigidly positioned.

13. The method of claim 10, wherein the positioning wings are moved by a respective lifting unit so that the distance of a blade held in the positioning wing, or of the receiving device of the positioning wing, from the turntable is adapted in dependence on the requirements of the respective processing station.

14. The method of claim 10, wherein the movement of the lifting units and/or the procedure at at least one processing station is synchronized with the movement and/or the angular position of the turntable of the rotary indexing table.

15. The method of claim 10, wherein an apparatus of claim 1 is used.
